(19) United States
(12) Patent Application Publication
(10) Pub. No.: US 2014/0223419 A1
(43) Pub. Date: Aug. 7, 2014

(54) COMPILER, OBJECT CODE GENERATION METHOD, INFORMATION PROCESSING APPARATUS, AND INFORMATION PROCESSING METHOD

(71) Applicant: Kabushiki Kaisha Toshiba, Tokyo (JP)

(72) Inventor: Ryuji SAKAI, Hanno-shi (JP)

(73) Assignee: Kabushiki Kaisha Toshiba, Tokyo (JP)

(21) Appl. No.: 14/015,670

(22) Filed: Aug. 30, 2013

Related U.S. Application Data
(63) Continuation of application No. PCT/JP2013/058157, filed on Mar. 21, 2013.

(30) Foreign Application Priority Data
Feb. 4, 2013 (JP) 2013-019259

(51) Int. Cl. G06F 9/45

(52) U.S. Cl. CPC G06F 8/45
USPC 717/149

(57) ABSTRACT

According to one embodiment, a compiler applicable to a parallel computer including processors, wherein a source program is input to the compiler and a local code for each of the processors are generated, the compiler includes a generation module and an object code generation module. The generation module is configured to analyze the input source program, extract a data transfer point from a procedure described in the source program, and generate a call processing for data copy. The object code generation module is configured to generate an object code including the call processing.

### CROSS REFERENCE TO RELATED APPLICATIONS

This application is a Continuation Application of PCT Application No. PCT/JP2013/058157, filed Mar. 21, 2013 and based upon and claiming the benefit of priority from Japanese Patent Application No. 2013-019259, filed Feb. 4, 2013, the entire contents of all of which are incorporated herein by reference.

### FIELD

Embodiments described herein relate generally to a compiler, an object code generation method, an information processing apparatus, and an information processing method.

### BACKGROUND

Conventionally, there is a multi-thread processing as a program execution model for multiple cores. In such a multi-thread processing, a plurality of threads as an execution unit operate in parallel, and exchange data on a main memory, thereby to accomplish parallel processings.

An example of an execution form of parallel processings described above includes two elements, i.e., a runtime processing including a scheduler which assigns a plurality of execution unit elements to execution units (CPU cores), and a thread which operates on each of the execution units. For parallel processings, synchronization between threads is significant. If a synchronization processing is not proper, problems such as a deadlock and inconsistency of data occur. Hence, conventionally, synchronization between threads is maintained by scheduling an execution order of threads and by performing parallel processings, based on the schedule.

Further, for a framework of heterogeneous multi-core, a runtime environment is demanded. The runtime environment implicitly performs data copy between a main memory of a host CPU and memories of devices such as an accelerator, including a GPGPU (General-purpose computing on graphics processing units; a technology which applies general-purpose calculations of a GPU and calculation resources of the GPU to other purposes than image processings).

For example, buffer synchronization and parallel runtime in an acceleration calculation environment are considered important. When a CPU and an accelerator such as a GPU card cooperate with each other to execute a large-scale calculation, buffers are defined and data is transferred to a memory of a calculating side, in order to exchange data between the CPU and the GPU.

At this time, at what timing and in which direction the data is transferred are complex and cause a bug to be mixed in coding. In particular, which of CPU, GPU1, GPU2, . . . , is to perform a calculation is changed in the course of a program tuning process, a timing and a direction of data transfer need to be carefully considered.

Therefore, a method has been proposed in which data is copied upon necessity on demand by defining a buffer view of abstracting buffers and by maintaining which memory includes newest data in a data structure of the buffer view. With use of this method, data transfer needs not explicitly be described on a program code but data can be properly transferred as needed. Therefore, a reliable program can be written with simple codes.

However, in the method of copying data on demand, a need for data copy is not clearly determined before a timing of calling a parallel calculation processing (hereinafter referred to as a kernel). Therefore, a delay of data copy needs to be accepted.

There is a demand for a technology capable of simply mounting a more efficient acceleration calculation program.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of a configuration of a whole system according to the embodiment.

FIG. 2 is a diagram of a functional block configuration showing an example of a system configuration of the embodiment.

FIG. 3A is a diagram for showing an example of an order of CPUs which call kernels, according to the embodiment.

FIG. 3B is a diagram for explaining a data flow, according to the embodiment.

FIG. 3C is a diagram for explaining a data processing sequence, according to the embodiment.

FIG. 3D is a diagram for explaining types of data and kernels, according to the embodiment.

FIG. 4 is a diagram for explaining an example of an operation principle of a general compiler.

FIG. 5 is a flowchart showing an example of calculation of a data copy point and insertion of a copy code, according to the embodiment.

FIG. 6A is a diagram for showing an example of an order in which CPUs calls kernels, according to the embodiment.

FIG. 6B is a diagram for explaining a data flow, according to the embodiment.

FIG. 6C is a diagram for explaining a data processing sequence, according to the embodiment.

FIG. 6D is a diagram for explaining an example of a data configuration of a buffer view, according to the embodiment.

FIG. 7 is a diagram showing another example of a configuration of a whole system, according to the embodiment.

FIG. 8 is a diagram of a functional block configuration showing an example of a system configuration employed in the embodiment.

### DETAILED DESCRIPTION

Various embodiments will be described hereinafter with reference to the accompanying drawings.

In general, according to one embodiment, a compiler applicable to a parallel computer including processors, wherein a source program is input to the compiler and a local code for each of the processors are generated, the compiler includes a generation module and an object code generation module. The generation module is configured to analyze the input source program, extract a data transfer point from a procedure described in the source program, and generate a call processing for data copy. The object code generation module is configured to generate an object code including the call processing.

### First Embodiment

The present embodiment relates to an object code generation method which can be used as an information processing apparatus or an information processing method, and is applicable to a compiler which is inputted with a source program and generates a local code for each of processors forming a parallel calculator. The object code generation method can generate local codes independent of processor configurations.

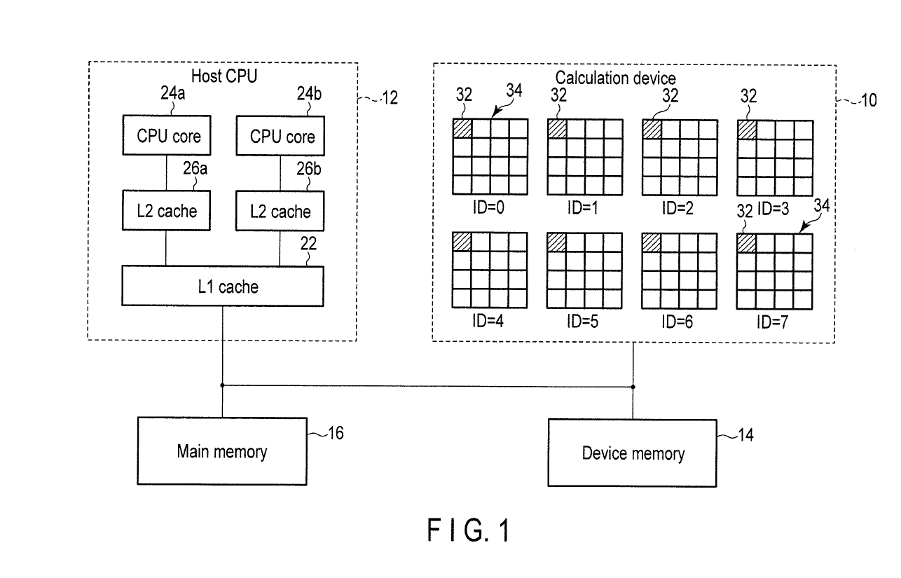

The first embodiment will be described with reference to FIGS. 1 to 8.

FIG. 1 shows an example of a configuration of a whole system according to the embodiment. For example, a calculation device 10 (hereinafter also referred to as a GPU) such as a GPU is controlled by a host CPU 12. The calculation device 10 is configured by a multi-core processor, and is divided into a large number of core blocks. In the example of FIG. 1, the calculation device 10 is divided into eight core blocks 34. The calculation device 10 can manage different contexts respectively for the core blocks 34. The core blocks 34 each are configured by 16 cores. By operating the core blocks or the cores in parallel, a high-speed parallel task processing can be performed.

The core blocks 34 are identified by block IDs. In the example of FIG. 1, the block IDs are 0 to 7. 16 cores in each block are identified by local IDs. The local IDs are 0 to 15. A core assigned with the local ID 0 is referred to as a representative core 32 of a block.

The host CPU 12 may also be a multi-core processor. The example of FIG. 1 supposes a dual-core processor. The host CPU 12 has a cache memory hierarchy of three steps. An L1 cache 22 connected to the main memory 16 is provided in the host CPU 12, and is connected to L2 caches 26a and 26b. The L2 caches 26a and 26b are connected to CPU cores 24a and 24b, respectively. The L1 cache 22 and L2 caches 26a and 26b have a hardware synchronization mechanism, and a required synchronization processing is performed when an identical address is accessed. The L2 caches 26a and 26b store data of an address referred to by the L1 cache 22. When a cache error occurs, a required synchronization processing is performed with the main memory 16 by the hardware synchronization mechanism.

The device memory 14 which can be accessed by the calculation device 10 is connected to the calculation device 10, and the main memory 16 is connected to the host CPU 12. Since two memories, which are the main memory 16 and the device memory 14, are connected, data is copied (synchronization) by the device memory 14 and the main memory 16 before and after executing a processing by the calculation device 10. Therefore, the main memory 16 and the device memory 14 are connected to each other. When a plurality of processings are performed successively, copy needs not be performed for each of the processings.

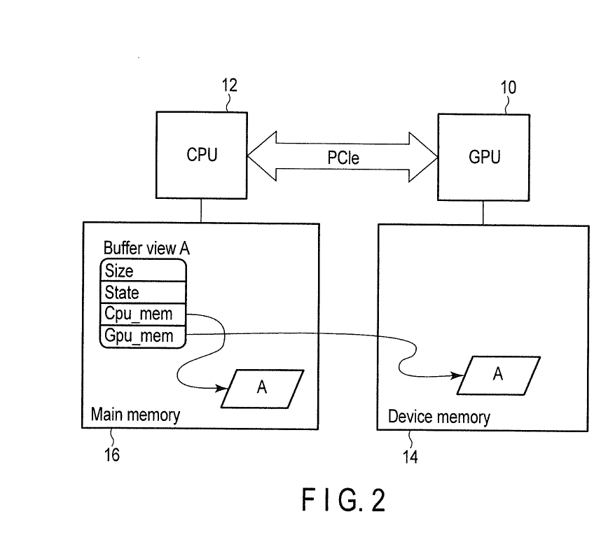

FIG. 2 shows an example of a system function configuration. The calculation device 10 is connected to the host CPU 12 via a PCIe (PCI Express), and the calculation device 10 includes the dedicated device memory (made of a DRAM) 14. The substance of a buffer which stores data used for calculations is allocated to each of the main memory 16 of the host CPU 12 and the device memory 14 of the calculation device 1. Statuses are managed by a data structure called BufferView.

This data structure includes four elements, as shown in FIG. 2. Supposing that object data shared by the host CPU 12 and GPU10 is data A, Size indicates a size (the number of bytes) of the data A. There are Cpu_mem and Gpu_mem in addition to State (status) which will be described next.

Cpu_mem is a pointer expressing the position of the data A in the main memory 16, and Gpu_mem is a pointer expressing the position of the data A in the device memory 14.

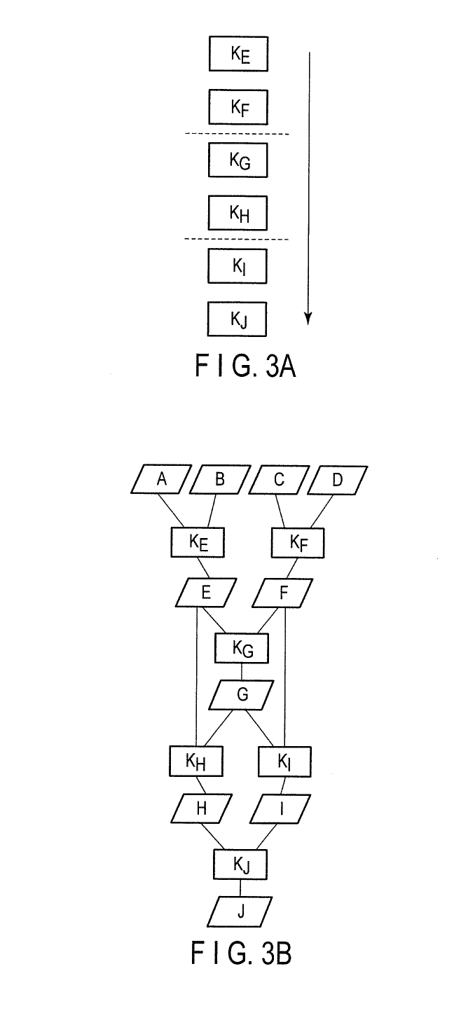

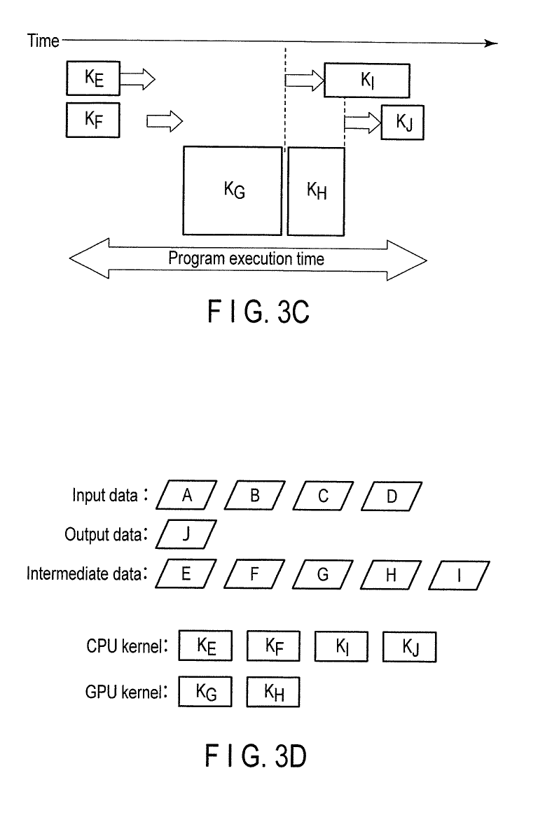

States of BufferView are managed by four states, i.e., CPU only, GPU only, Shared, and Undefined (the statuses increase as calculation devices increase). FIG. 3A shows an “order of calling kernel functions by the host CPU 12”. FIG. 3A shows a kernel call described in a program code. In the example of the figure, kernel functions K_{B}, K_{F}, K_{I}, and K_{J} are executed by the host CPU 12, and kernel functions K_{G} and K_{H} are executed by the GPU 20. FIG. 3B shows an example of a data flow of whole processings. FIG. 3C shows an example of a data processing sequence. FIG. 3D shows an example of types of data and kernels.

According to the prior art, data copy is performed on demand. As shown in FIGS. 3A to 3D, when the kernel K_{E} is executed on the host CPU 12, the status of BufferView E is “CPU only”. The same also applies to the kernel K_{F}. Here, when the kernel K_{H} executed by the GPU is called, the statuses of BufferView E and BufferView F are checked. Since the status is “CPU only”, data copy is started. Upon completion of the copy, the status is changed into “Shared”. Similarly, when the kernels K_{G} and K_{H} end, BufferView G and BufferView H are in the status of “GPU only”. Before the kernel K_{I} is called, copy of the BufferView G is not started. Therefore, start of execution of the kernel K_{I} is delayed.

In order to solve this, copy of BufferView G may be started immediately after the end of the kernel K_{G}. However, programming is then complicated and spoils convenience of abstraction using BufferView.

A schematic configuration of a general compiler which is configured by employing an object code generation method according to the present embodiment includes a compiler, an optimization converter, and a code generation section. The compiler reads a source program, analyzes syntax, converts the program into an intermediate code, and stores the code into a memory. Specifically, the syntax of a source program is analyzed, and an intermediate code is generated. Thereafter, optimization, code generation, and outputting of an object code are performed. In the course of this optimization, there is a flow of control flow analysis, data dependence analysis, and various optimization (intermediate code generation). Analysis of a Def-Use chain described later is data-dependent analysis, and insertion of a data transfer code is a function which is achieved by various optimization and a code generation section.

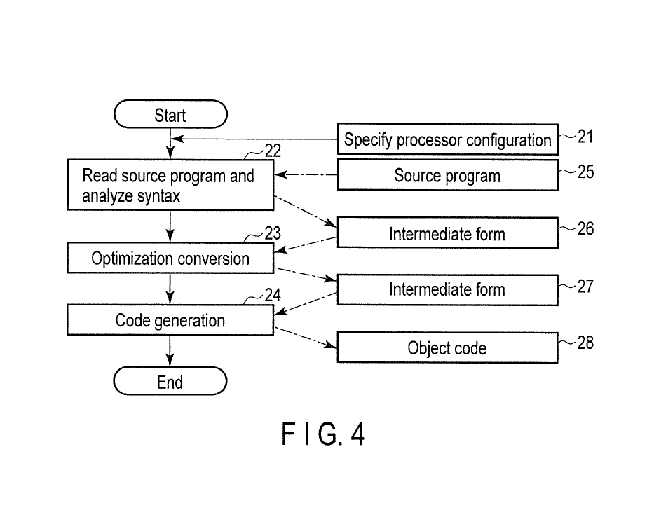

Here, an outline of an operation procedure of a general parallel compiler will be described with reference to FIG. 4.

At first, in the beginning of compilation, a configuration B21 of a target processor is specified. In addition, the configuration may be specified by quoting what is called a compiler specifier. Further, the compiler reads a source program B25 in Step S22, analyzes syntax of the source program B25, and converts the source program B25 into an intermediate form B26 which is an internal expression.

Next, the compiler performs various optimization conversions on the intermediate form (internal expression) B26 in Step S23, and generates a converted intermediate form B27.

Next, the compiler scans in Step S24 the intermediate form B27 converted, and generates an object code B28 for each PE. As an operation example of the compiler, a machine language code is generated from a program of a C language system.

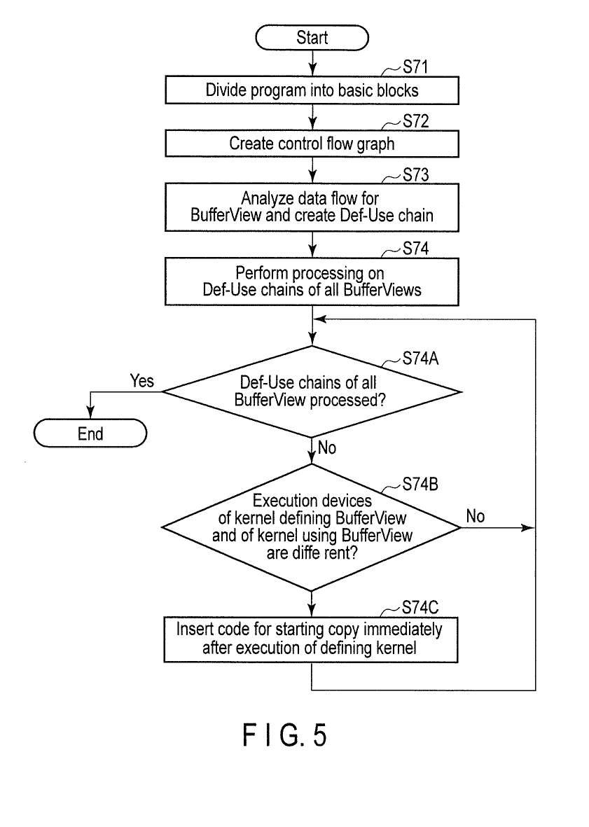

In the present embodiment, as shown in FIG. 5, a data flow is analyzed at the time of compiling a program. Only when needed, a code for starting data copy is inserted. Specifically, a Def-Use chain of BufferView is analyzed. Only if executing devices of a kernel to be subject to Def and a kernel to be subject to Use are different, a code of kicking data copy is inserted immediately after the kernel to be subject to Def. In this manner, prediction of data is possible with maintaining programs simple. As shown in a time chart in FIG. 3C, execution of the kernel K_{I} can be started early (see broken lines from K_{G} to K_{I} and from K_{H} to K_{J} in FIG. 3C, and conventionally, transition to KI occurs after K_{H} is completed), and a total execution time can be shortened. FIG. 3D lists data and attributes of kernels concerning the data flow of FIG. 3B.

The Def-Use chain is called a du-chain (definition-use chain). Creation of a definition-use chain (du-chain) is substantially the same calculation as analysis of a valid variable. For example, if a variable requires a right side value in a sentence s, the variable is used in s. For example, where a sentence a:=b+c and a sentence a[b]:=c, b and c are used in the respective sentences (a is not used). A problem concerning the du-chain is to obtain a set of the sentences s which use a variable x about a point p. Specific steps are as follows.

Step S71: Divide a program into basic blocks.

Step S72: Create a graph of a control flow.

Step S73: Analyze a data flow with respect to a BufferView and create a Def-Use chain.

Perform the following processings on Def-Use chains of all BufferViews.

Step S74A: Determine whether processings of Def-Use chains of all BufferViews have been performed or not. If the processings are determined to have been performed, a processing loop up to Step S74C ends, and the whole processings are terminated.

Step S74B: Determine whether an execution device of the kernel which subjects BufferView to Def and an execution device of the kernel which subjects BufferView to Use are different from each other or not. If this determination results in Yes, the flow goes to next Step S74C. If No, the flow returns to Step S74A.

Step S74C: Insert a code which starts data copy immediately after execution of the kernel to be subject to Def. The code for generating a call processing for this data copy is realized, for example, by a function.

The basic blocks are a sequence of continuous sentences in which control is given to the top sentence and thereafter leaves from the last sentence without stopping or branching halfway. For example, a so-called sequence of three addresses form basic blocks.

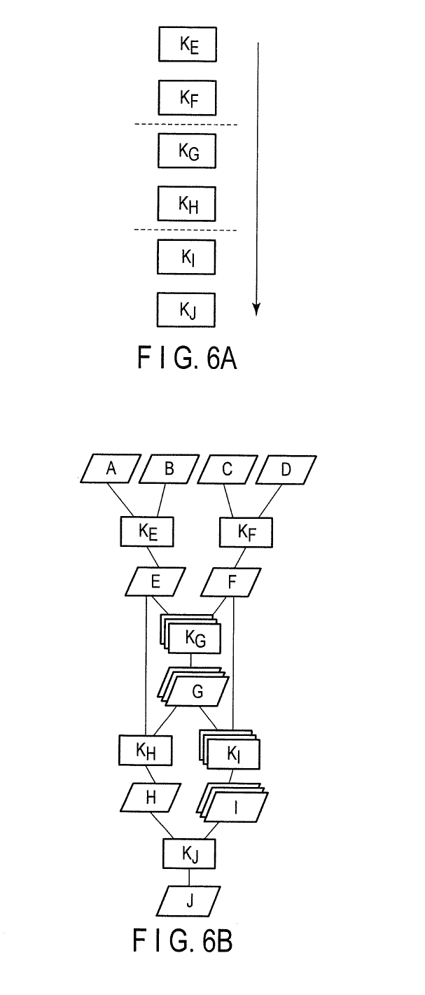

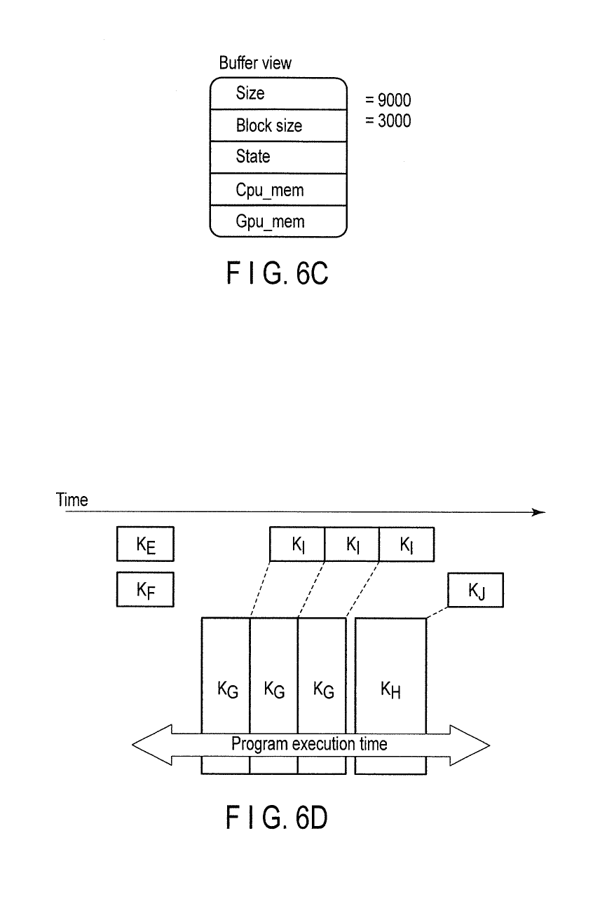

Further, as shown in FIG. 6D, defining a data division method (BlockSize) in BufferView in advance is applied to buffers G and I. Kernels K_{G} and K_{I} are divisionally executed in consideration of executing the kernel K_{I} by a CPU having a low parallel degree (see the kernels K_{G} and K_{I} in FIG. 6A and FIG. 6B). A total execution time can be thereby shortened (see the three broken lines from the kernels K_{G} to K_{I} in FIG. 6C). The BlockSize (3000 bytes) is a value obtained by dividing Size (9000 bytes) by three. FIG. 6A shows an example of an order in which CPUs call kernels. FIG. 6B shows an example of a data flow. FIG. 6C shows an example of a data structure of a Buffer View. FIG. 6D shows an example of a data processing sequence.

### Second Embodiment

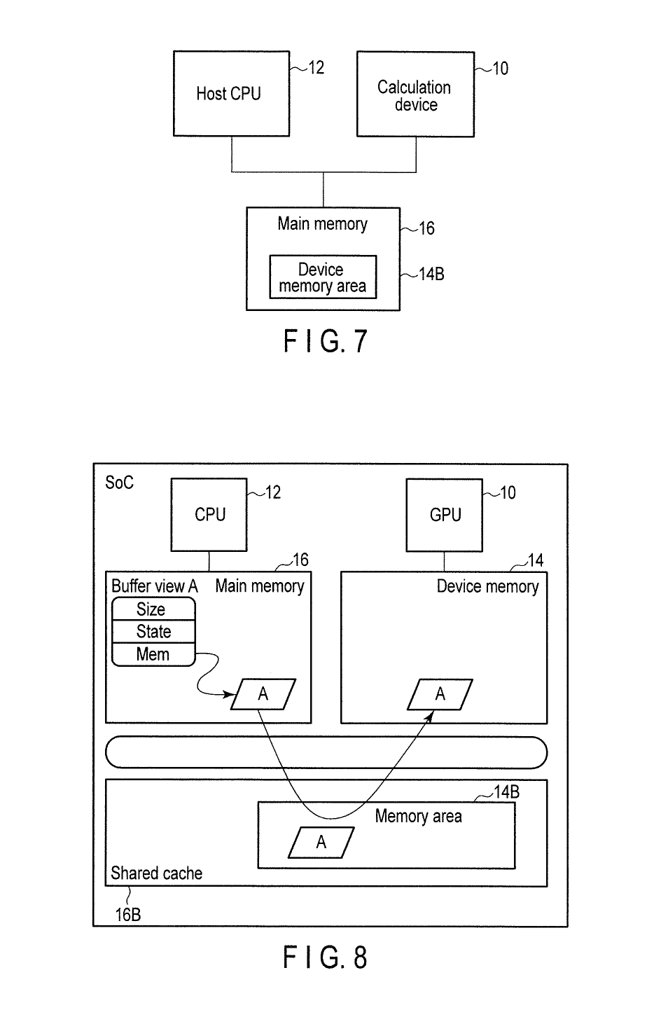

The second embodiment will be described with reference to FIGS. 7 to 8. Parts common to the first embodiment will be omitted.

FIG. 7 shows another example of system configuration. Here, a device memory 14 is not provided independently. The calculation device 10 and the host CPU 12 share the main memory 16. A device memory area 14B equivalent to the device memory 14 in FIG. 1 is provided in the main memory 16. In this case, data copy needs not be performed between the device memory and the main memory.

As shown in functional blocks in FIG. 8, the memory area 14B is provided so as to intervene with a shared cache 16B, in the present embodiment.

As a result, in a SoC (System on Chip) which integrates a CPU and a GPU, data copy in the embodiment is substituted with prefetch to a cache and becomes an effective measure to improve performance in simple program description even when a CPU, a GPU, and any other accelerator share a memory. In addition, mem is a pointer indicating the position of the data A in the shared cache 16B.

As described above, a highly efficient program can be created by automatically hiding a delay of data transfer in an environment in which complicated and time-consuming GPU programming is simplified.

According to the embodiments, the followings are practiced in a runtime environment which implicitly performs data copy between memories of devices, such as accelerators including a GPU, and to/from a main memory of a host CPU by abstracting data buffers to calculate.

(1) A data copy is not performed on demand but a data copy is performed as early as possible. In this manner, delays in data transfer are reduced and performance is improved.

(2) Since data is copied at an early time point, a processing for calling data copy is generated to obtain a data transfer point when a program is complied.

(3) When a calculation is performed by a device which has a relatively low parallel degree, such as a multi-core CPU, an input data buffer is subdivided to make data flow in form of a stream and to set early calculation start timings in a multi-core CPU. System performance is thereby improved.

According to the embodiments, a programmer can create a program which starts data copy at a proper timing without describing a transfer processing for data. Therefore, an efficient acceleration calculation program can be mounted simply.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A compiler applicable to a parallel computer comprising processors, wherein a source program is input to the compiler and a local code for each of the processors are generated, the compiler comprising:
a generation module configured to analyze the input source program, extract a data transfer point from a procedure described in the source program, and generate a call processing for data copy; and
an object code generation module configured to generate an object code including the call processing.

2. The compiler of claim 1, wherein the data transfer point is divided for each of the processors.

3. The compiler of claim 1, wherein the call processing for data copy is generated in substitution with prefetch to a shared cache among the processors.

4. An information possessing apparatus comprising:
a CPU or an accelerator, as the processor, configured to execute an object code generated by the compiler of claim 1.

5. An object code generation method for a compiler applicable to a parallel computer comprising processors, wherein a source program is input to the compiler and a local code for each of the processors are generated, the method comprising:
a generation step which analyzes the input source program, extract a data transfer point from a procedure described in the source program, and generate a call processing for data copy; and
a generation step which generates an object code including the call processing.

6. The method of claim 5, wherein the data transfer point is divided for each of the processors.

7. The method of claim 5, wherein the call processing for data copy is generated in substitution with prefetch to a shared cache among the processors.

8. An information processing method of executing the object code generated by the object code generation method of claim 5.
